(19) United States
(12) Patent Application Publication
(10) Pub. No.: US 2009/0024424 A1
(43) Pub. Date: Jan. 22, 2009

(54) SYSTEM AND METHOD FOR DYNAMIC LINKING OF BUSINESS PROCESSES

(76) Inventors: ANTONY RAJA T, Tirunelveli (IN); Ruchi Gupta, Bangalore (IN); Ganesh Kudva, Bangalore (IN)

Correspondence Address: SAP AG, 3410 HILLVIEW AVENUE, PALO ALTO, CA, 94304, US

(21) Appl. No.: 11/778,102

(22) Filed: Jul. 16, 2007

(51) Int. Cl. G06F 9/44

(52) U.S. Cl. 705/7

(57) ABSTRACT

An embodiment of the invention provides a system and a method for dynamically linking of a business process that allows switching between the business processes based on business needs at pre-defined places of the business process. A business process is a set of tasks or activities that are to be performed to complete a transaction. These switching between the business processes are dependent on the context in which the business processes are used. This context can be defined and modified based upon the changing needs of the business. The invention allows the same business process to be utilized in different contexts without the need for redevelopment. In one embodiment, to implement the dynamic linking of the business process, a business process service layer is provided that process developers can leverage to add points of variability in their processes. The business process service layer talks to a server platform which in turn can execute business logic using the business process database. The business process is built by reusing the existing business processes and linking between these business processes. Thus, this reusability of the business process makes it possible to tailor the process as per the changing needs of the business.

### FIELD OF THE INVENTION

Embodiments of the invention generally relate to the field of managing business processes. More particularly, the invention relates to system and methods for dynamic linking of business processes.

### BACKGROUND OF THE INVENTION

Enterprise software applications are widely used in industries for performing several tasks. Examples of these tasks are; for managing inventories, for managing production schedules, for managing customer relations, for supply chain management, for human resource management and for finance and controlling tasks. Several software manufacturers are engaged in developing and maintaining these enterprise software applications based on the industry needs and purposes. Certain specialized software applications are optimized for a particular function or a task, while some others are more efficient in handling region specific issues. Large industries have huge IT infrastructure implemented in several geographies. This IT infrastructure implementation and maintenance is complex and expensive as there is very little reusability.

To provide a better integration between this geographical IT infrastructure, software manufacturers have used several approaches to solve this problem. The two most popular approaches are; one is to build country specific software from a scratch and second is to build generic software for a function and later customize the software based on the geography of operation. As the former has country specific functionality in their package software and hence often during the package software implementation in an industry based on the industry requirements, the packaged software has to be customized as per the geographical business needs. Packaged software is used for a specific business activity. The package software may have several business processes based on the functionality it is delivering and based on the required business logic. A business process is a sequence of linked activities followed in a business to achieve a specific business goal. The business process creates value by transforming an input into a more valuable output.

For example, an employee's portal (Intranet) contains links to several business processes. When the employee wishes to update personal information such as address, phone numbers there are multiple business processes available to maintain address based on the geography of the employee. Hence maintaining foreign address of an employee in a country specific version of software is a problem.

Often there can be a scenario where there is a mix of multiple business processes between software applications. Often switching between the multiple business processes can be a problem. Further for implementing such a switching between multiple business processes, the developers are usually required to duplicate parts of the business processes into a software application. This duplicating task is repetitive and leads to a higher cost of application development and subsequent a higher maintenance cost. Today, there is no dynamic business process linking available. Currently, separate business processes are created to solve unique business tasks, but they lack the capability to be reused dynamically based on new business requirements. What is a needed is a system and method to link the existing business processes based on the needs of business. Further what is needed is a system and method that would allow the same business process to be used in different contexts without the need for software redevelopment.

### SUMMARY OF THE INVENTION

An embodiment of the invention provides a system and a method for dynamically linking of a business process that allows switching between the business processes based on business needs at pre-defined places of the business process. A business process is a set of tasks or activities that are to be performed to complete a transaction. These switching between the business processes are dependent on the context in which the business processes are used. This context can be defined and modified based upon the changing needs of the business. The invention allows the same business process to be utilized in different contexts without the need for redevelopment. In one embodiment, to implement the dynamic linking of the business process, a business process service layer is provided that process developers can leverage to add points of variability in their processes. The business process service layer talks to a server platform which in turn can execute business logic using the business process database. The business process is built by reusing the existing business processes and linking between these business processes. Thus, this reusability of the business process makes it possible to tailor the process as per the changing needs of the business.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a system block diagram illustrating a dynamic linking of business processes, according to an embodiment of the invention.

FIG. 2 is a flow diagram illustrating the dynamic linking of business processes, according to an embodiment of the invention.

FIG. 3 is a process block diagram illustrating an implementation for dynamic linking of a business process from an available set of business process, according to an embodiment of the invention.

FIG. 4 illustrates how a personal address can be added, edited, saved and reviewed in separate geographical software systems, according to an embodiment of the invention.

FIG. 5 is a graphical user interface providing a service list of data, according to an embodiment of the invention.

FIG. 6 is a graphical user interface providing an overview of an address of the business user, according to an embodiment of the invention.

FIG. 7 is a graphical user interface providing for editing of German address of the business user in the German software application, according to an embodiment of the invention.

FIG. 8 is a graphical user interface providing for switching from the German software application to the American software application based on the business requirement, according to an embodiment of the invention.

FIG. 9 is a graphical user interface providing for editing of the American address of the business user in the American software application, according to an embodiment of the invention.

FIG. 10 is a graphical user interface providing for reviewing and saving of the American address of the business user, according to an embodiment of the invention.

FIG. 11 is a graphical user interface providing confirmation of the saved American address of the business user, according to an embodiment of the invention.

FIG. 12 is a graphical user interface providing confirmation of the saved American address of the business user and providing an option to restart the process of updating address of the business user, according to an embodiment of the invention.

### DETAILED DESCRIPTION

An embodiment of the invention provides a system and a method for dynamically linking of a business process that allows switching between the business processes based on business needs at pre-defined places of the business process. A business process is a set of tasks or activities that are to be performed to complete a transaction. These switching between the business processes are dependent on the context in which the business processes are used. This context can be defined and modified based upon the changing needs of the business. The invention allows the same business process to be utilized in different contexts without the need for redevelopment. In one embodiment, to implement the dynamic linking of the business process, a business process service layer is provided that process developers can leverage to add points of variability in their processes. The business process service layer talks to a server platform which in turn can execute business logic using the business process database. The business process is built by reusing the existing business processes and linking between these business processes. Thus, this reusability of the business process makes it possible to tailor the process as per the changing needs of the business.

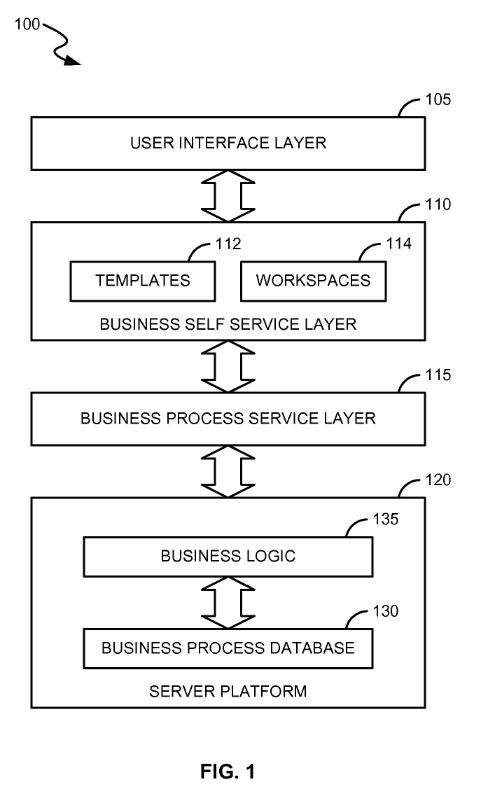

FIG. 1 is a block diagram illustrating a dynamic linking of business processes, according to an embodiment of the invention. In an enterprise environment 100, the user interface layer 105 interacts with a business self service layer 110, which interacts with the business process service layer 115 and which in turn interacts with a server platform 120. The user interface layer 105 includes, for example SAP.RTM Webdynpro Screens in an SAP R/3 system. The business self service layer 110 includes templates 112 and business process workspaces 114. The templates 112 are a set of documents or files having a preset format, used as a starting point for a particular application so that the format does not have to be recreated each time it is used. The workspaces 114 provide the business user with option to create or to generate documents. The business self service layer 110 collects the incoming data of the business processes, validates and processes the data. In one embodiment, the business self service layer 110 is built on SAP.RTM Netweaver technology. The business process service layer 115 allows process developers to configure and manage business processes. The business process service layer 115 provides a layer of abstraction over the underlying infrastructure so that developers can interact with higher level abstractions that make sense to them without bothering about complex lower level infrastructure. The server platform 120 includes, for example the business logic 135 and business process database 130. The business process database 130 stores the business processes of the software application. Based on the business logic 135, the system establishes a link amongst the business processes.

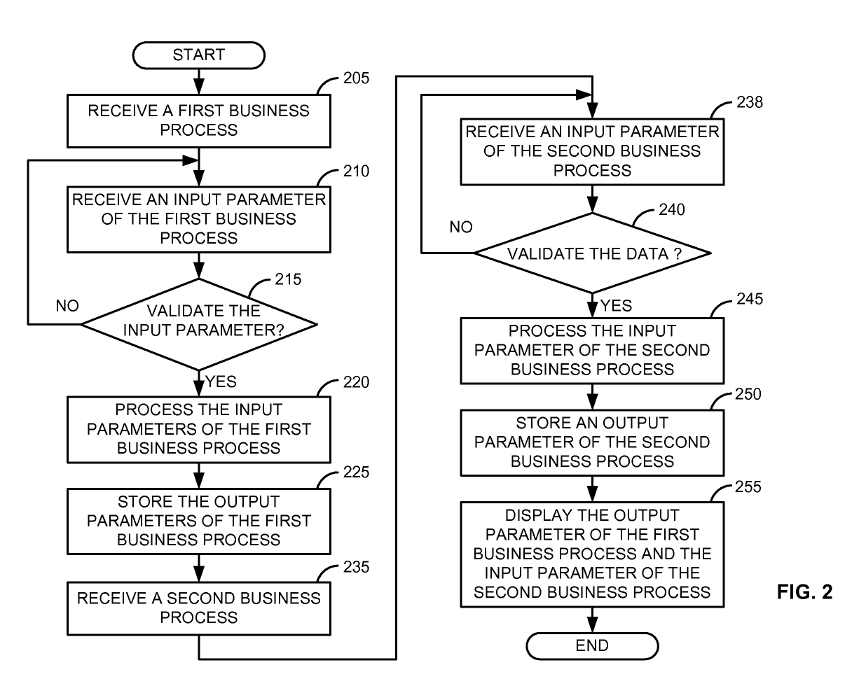

FIG. 2 is a flow diagram illustrating the dynamic linking of business processes, according to an embodiment of the invention. At 205, receive a first business process from the business process database. At 210, receive an input parameter of the first business process using the business self service layer. At 215, validate the input parameter received from the business process database, using the business self service layer and at 220, process such validated parameter using the business process service layer otherwise, return to step 210. At 225, the server platform stores the output parameter of the first business process in the business process database. At 235, receive a second business process from the business process database. At 238, receive an input parameter of the second business process from the business process database using the business self service layer. At 240, validate the input parameter of the second business process using the business self service layer and at 245, process such a validated input parameter of the second business process using the business process service layer. At 250, the server platform stores the output parameter of the second business process in the business process database. At 255, display the output parameter of the first business process and the input parameter of the second business process using the user interface layer.

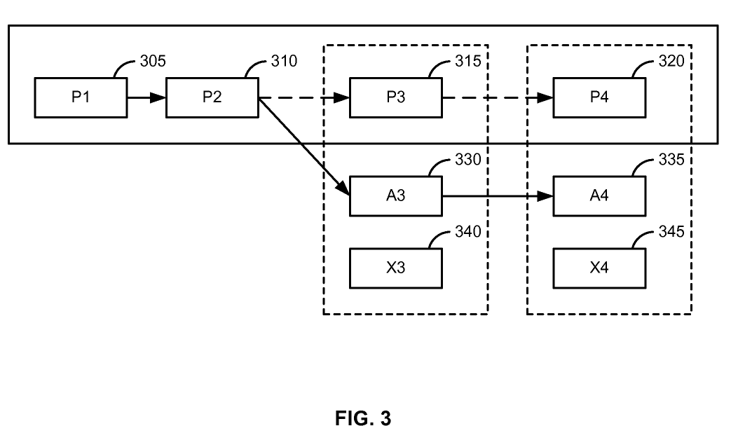

FIG. 3 is a process block diagram illustrating an implementation for dynamic linking of the business process from an available set of business processes, according to an embodiment of the invention. A country specific version of software contains several business processes as illustrated by business process P1 305, business process P2 310, business process P3 315 and business process P4 320. Another country specific version of the software contains other business processes such as business process A3 330 and business process A4 335, and a third country specific version of software has another business processes, such as business process X3 340 and business process X4 345. Each of above business process is maintained in the business process database and on launching a software application, the default host country based on the business user's credentials is obtained. The business process continues as per the credentials of the business user and the business process service layer using the business logic to process each business process independently. As illustrated by FIG. 3, after the business process P1 305 is processed, subsequently the business process P2 310, the business process P3 315 and the business process P4 320 are processed in order. However, if a user requires maintaining the data in another country specific software version, then the corresponding business process of that software is executed based on the business logic. Based on the business logic the business process P3 315, the business process A3 330 or business process X3 340 can be switched. Based on the business logic the corresponding business process A3 330 is executed and later business process A4 335 is executed till the process is completed. The business logic of the server platform and the business process service layer provides for dynamic linking of business process from the available set of business processes.

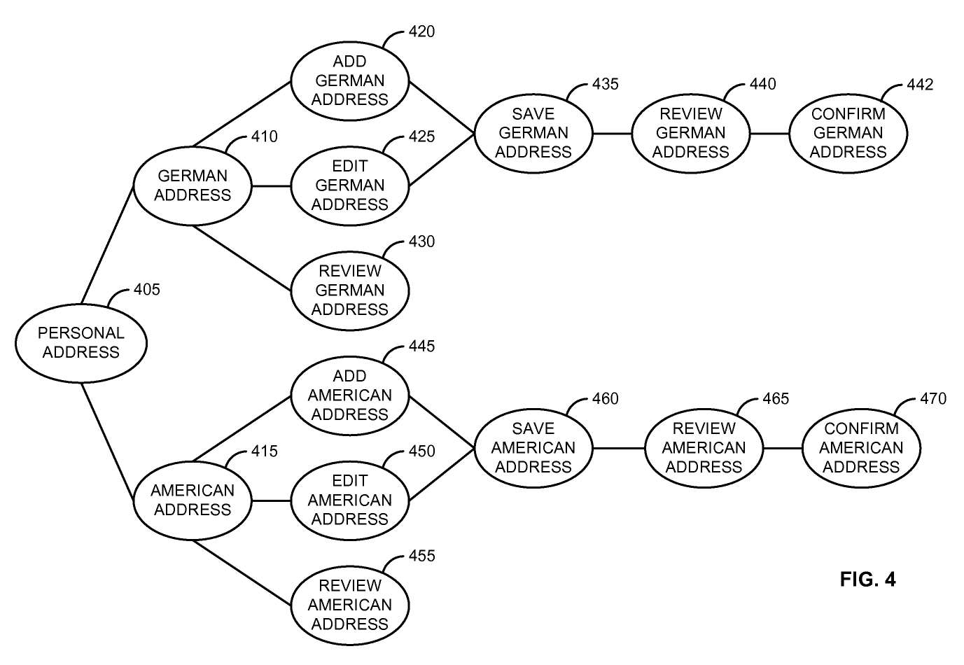

FIG. 4 illustrates how a personal address can be added, edited, reviewed, and saved in separate geographical software applications, according to an embodiment of the invention. A software application has several business processes stored in the business process database. Each such business process can perform an independent function. As illustrated, a business user's personal address 405 is to be updated into the software application. Based on the user's credentials maintained with the software application, the software provides for geography specific address, such as German address 410 or American address 415. For a German user based on his credentials, the user's German address will be displayed. The user can add 445, edit 450 or review 455 this address. The added 420 or edited 425 German address, is saved 435 and further the German address can be reviewed 440 and confirmed 442. Further, the user may be required to also maintain an American address with the software and so the business process switches from German business process to American business process. After this linking of American address for a German business user, the business user is provided with similar add 445, edit 450 and review 455 American address functions. The updated address can be saved 460, reviewed 465 and confirmed 470 for later use.

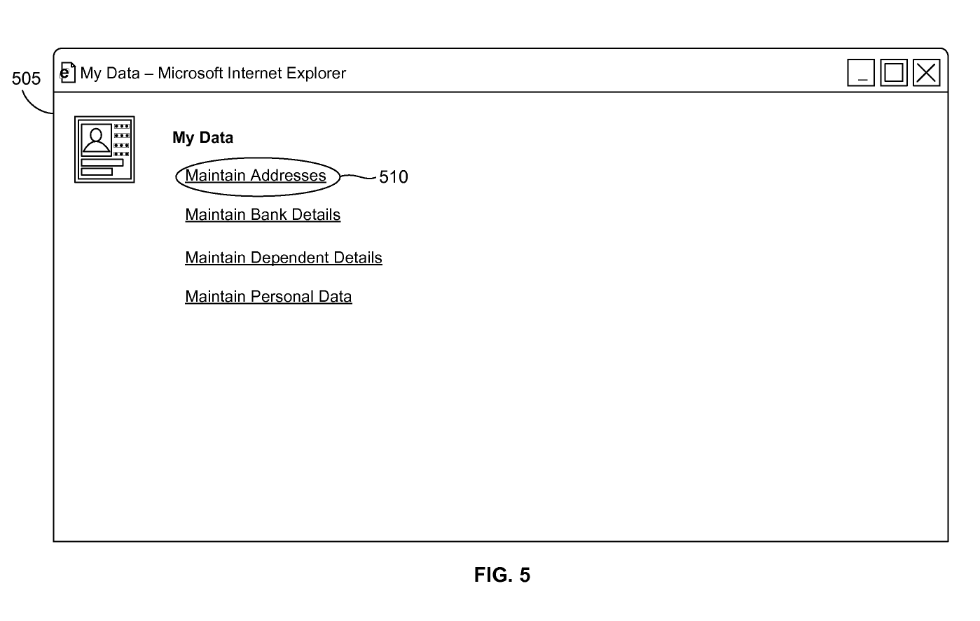

FIG. 5 through FIG. 12 are graphical user interface illustrates an exemplary end to end process for utilizing the present invention for run-time use of the dynamically linking of business process, according to an embodiment of the invention.

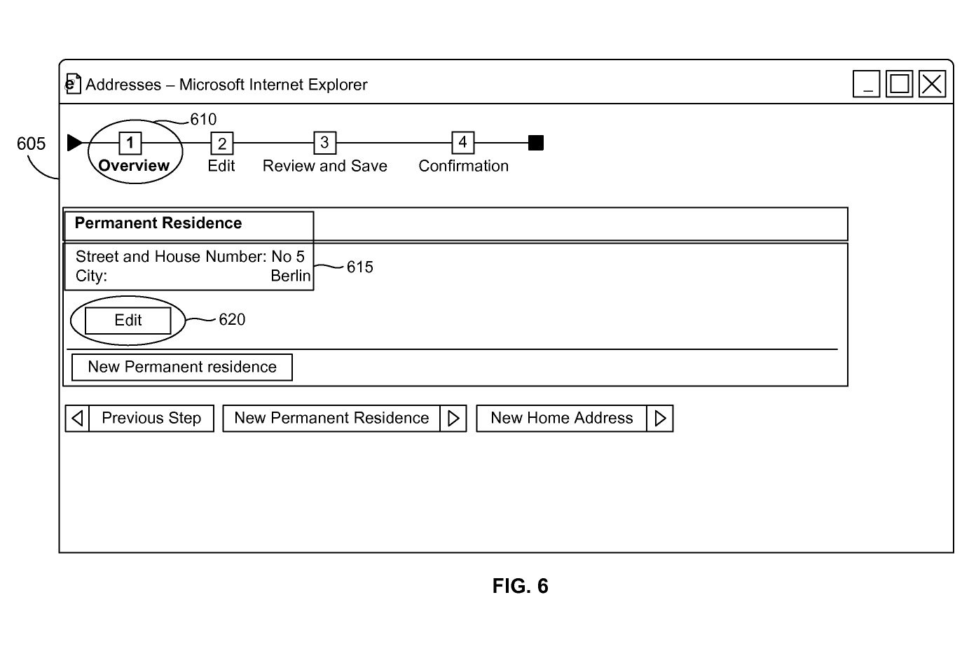

FIG. 5 is a graphical user interface providing a service list, according to an embodiment of the invention. As illustrated the user interface allows for maintenance of data with the software. Several types of data are maintained in the software such as maintain address 510. On selecting the maintain address, the user interface of FIG. 6 appears.

FIG. 6 is a graphical user interface providing an overview of the address of the business user, according to an embodiment of the invention. Based on the business user's credentials maintained with the system, the user interface 605 provides an overview 610 of the data. The data displayed is the local address of the business user such as German address 615. The business user can edit this address 620.

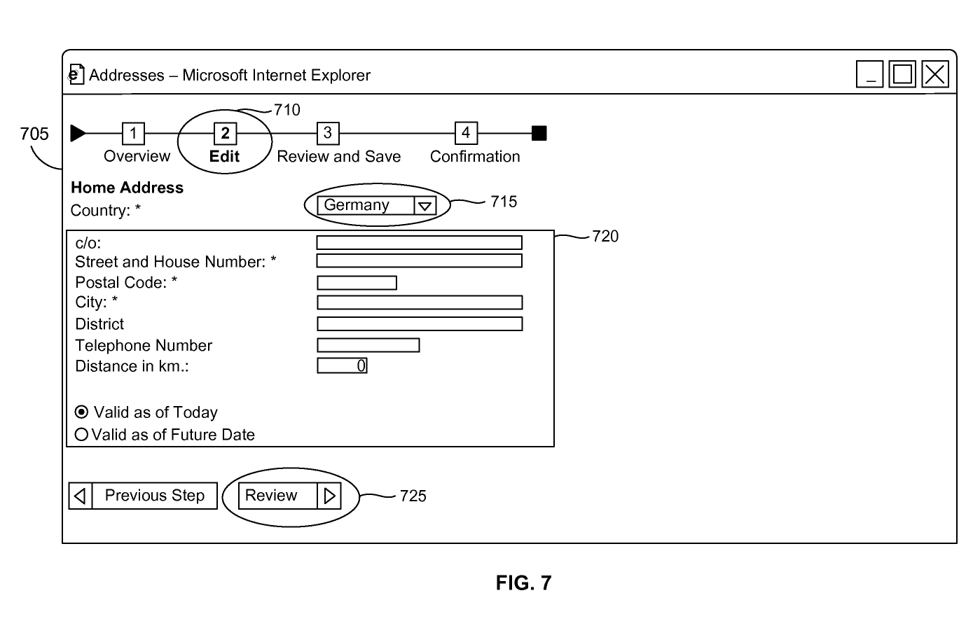

FIG. 7 is a graphical user interface providing for editing of German address of the business user, according to an embodiment of the invention. The user interface 705 provides for editing 710 of the business user's German address 715. The German address 715 can be edited 720 and saved post its review 725.

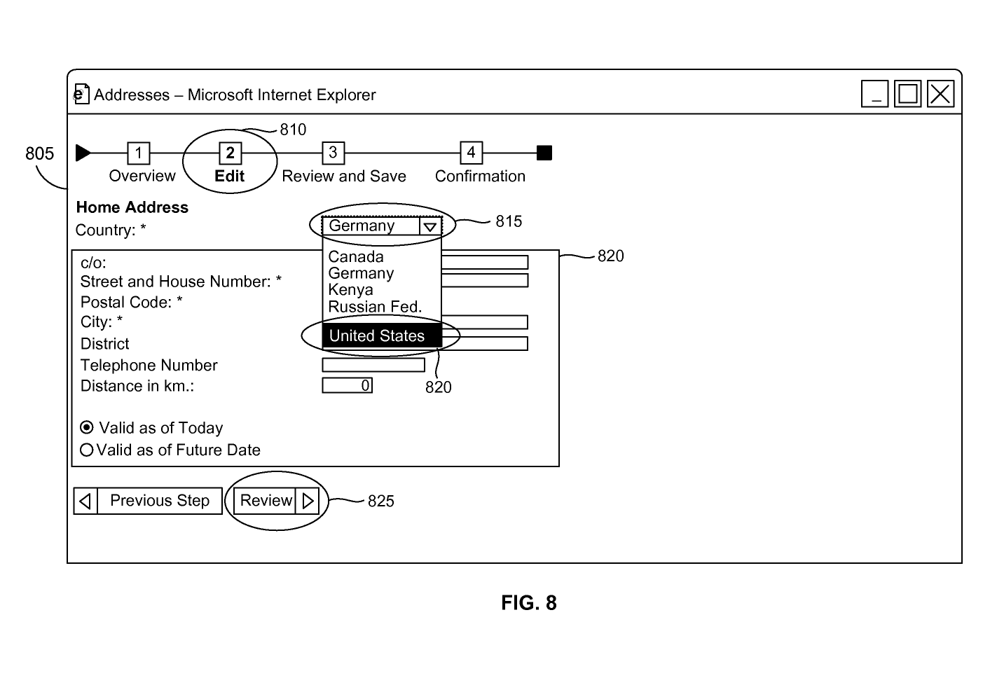

FIG. 8 is a graphical user interface providing for switching from the German address to the American address based on the business requirement for the business user, according to an embodiment of the invention. The user interface 805 provides for editing 810 of the business user's address from German address 815 to United States address 820. The United States (American) address 820 can be edited and saved post its review 825.

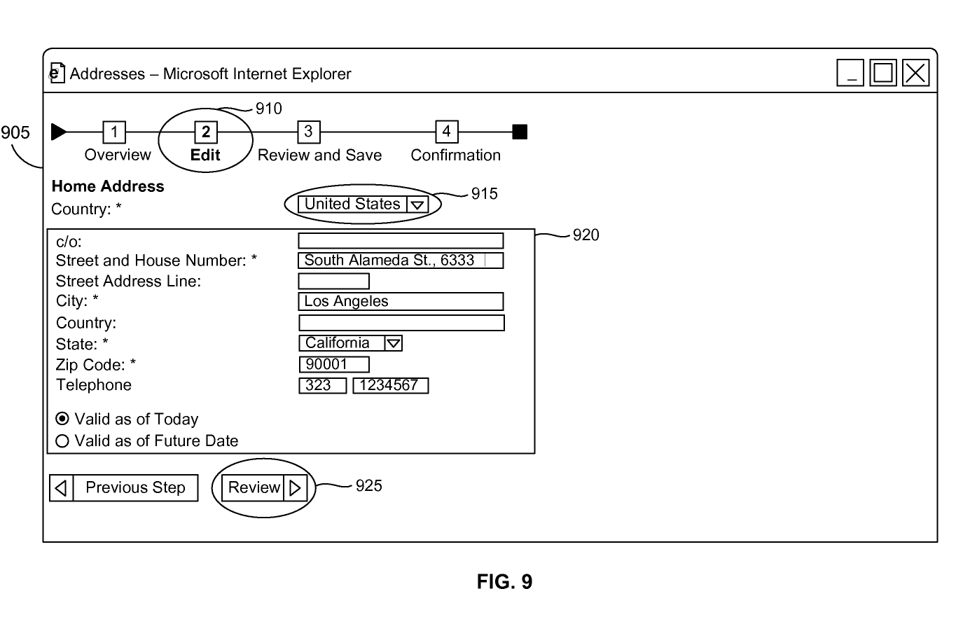

FIG. 9 is a graphical user interface providing for editing of the American address of the business user, according to an embodiment of the invention. The user interface 905 provides for editing 910 of the business user's American address 915. The address template changes from the German format to the American format 920 and the American address 920 can be saved post its review 925.

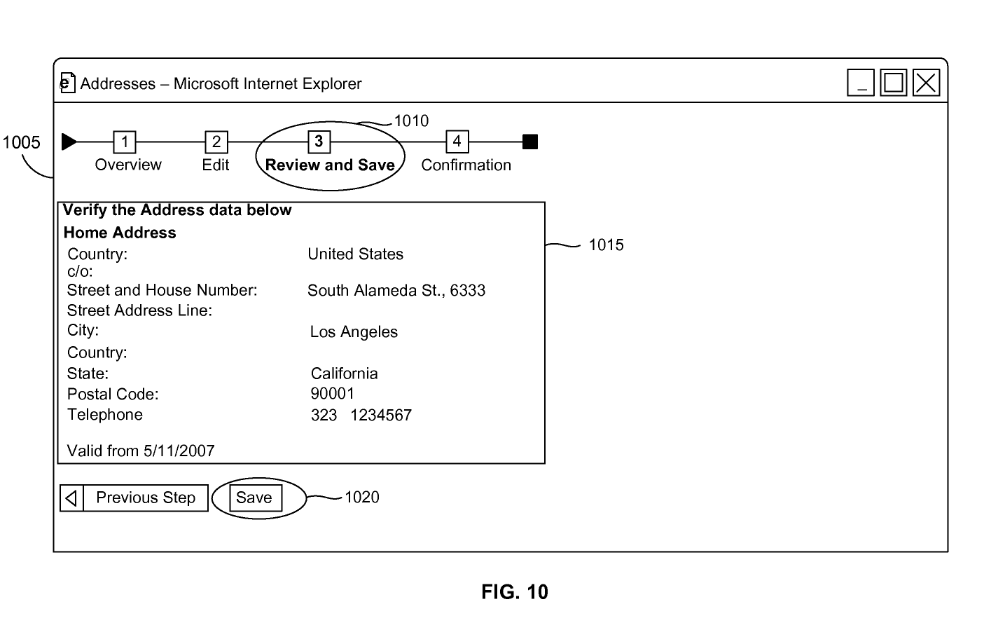

FIG. 10 is a graphical user interface providing for review and saving 1010 of the American address of the business user, according to an embodiment of the invention. The user interface 1005 provides for reviewing and saving of the American address 1015. The reviewed American address 1015 can be saved 1020.

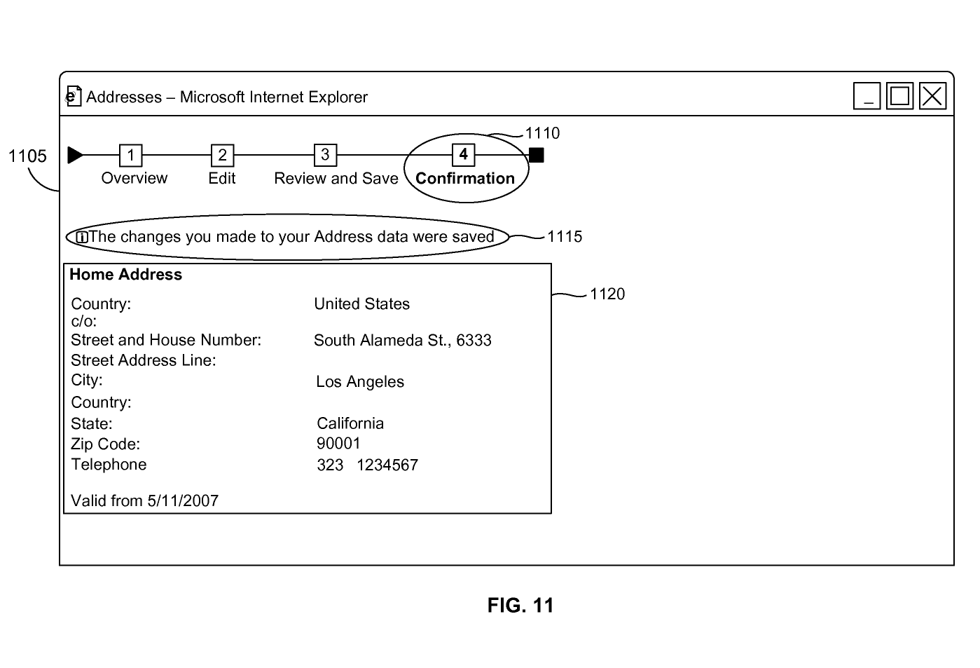

FIG. 11 is a graphical user interface providing confirmation of the saved address of the business user, according to an embodiment of the invention. The user interface 1105 provides for confirmation 1110 using a confirmation message 1115 for the saved American address 1120.

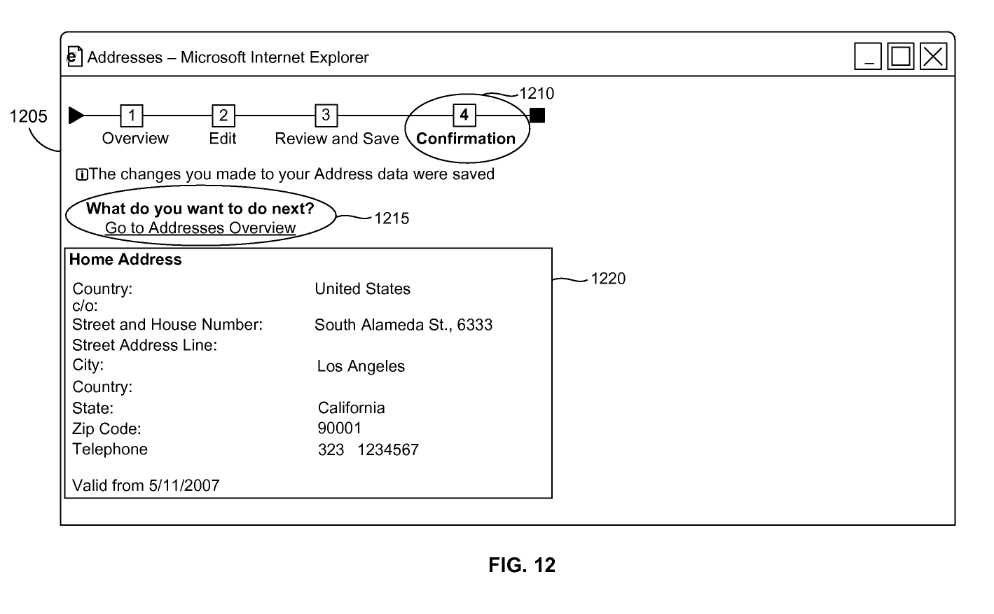

FIG. 12 is a graphical user interface providing confirmation of the saved American address of the business user and providing an option to restart the process of updating address of the business user, according to an embodiment of the invention. The user interface 1205 provides a confirmation screen 1210 along with the saved address 1220. Further the user interface provides for an option to restart the process 1215 and getting back to the user interface of FIG. 5.

Other embodiments of the invention may be implemented in digital electronic circuitry, or in computer hardware, firmware, software, or in combinations of them.

Elements of the invention may also be provided as a machine-readable medium for storing the machine-executable instructions. The machine-readable medium may include, but is not limited to, Flash memory, optical disks, CD-ROMs, DVD ROMs, RAMs, EPROMs, EEPROMs, magnetic or optical cards, propagation media or other type of machine-readable media suitable for storing electronic instructions.

Throughout the foregoing description, for the purposes of explanation, numerous specific details were set forth in order to provide a thorough understanding of the invention. It will be apparent, however, to one skilled in the art that the invention may be practiced without some of these specific details. The underlying principles of the invention may be employed using a virtually unlimited number of different types of input data and associated actions.

Accordingly, the scope and spirit of the invention should be judged in terms of the claims which follow.

What is claimed is:

1. A computerized method for linking of business processes, comprising:
receiving a first business process;
storing an output parameter of the first business process;
receiving a second business process;
receiving an input parameter of the second business process based on the output parameter of the first business process;
processing the input parameter of the second business process based on the business logic;
storing an output parameter of the second business process; and
displaying the output parameter of the first business process and the input parameter of the second business process.

2. The method in claim 1, further comprising modeling of the first business process.

3. The method in claim 1, further comprising modeling of the second business process.

4. The method in claim 1, further comprising receiving the input parameter of the first business process.

5. The method in claim 1, further comprising validating the input parameter of the first business process.

6. The method in claim 1, further comprising processing the input parameter of the first business process.

7. The method in claim 1, further comprising validating the input parameter of the second business process.

8. The method in claim 1, wherein said business processes are linked business process.

9. The method in claim 8, wherein displaying the linked business processes.

10. The method of claim 1, wherein the business process comprises a set of business processes.

11. A system for linking of business processes, comprising:
a user interface layer for displaying the screens containing output parameter of the first business process and the input parameter of the second business process;
a business self service layer for collecting and validating a received data;
a business process service layer for linking between a business processes; and
a server platform for processing based on a business logic and for connecting to a business process database.

12. The system in claim 11, wherein the server platform comprises:
the business logic module for providing the business process linking logic; and
the business process database for storing the business processes.

13. The system in claim 11, wherein the business self service layer further comprises a template of the screens.

14. The system in claim 11, wherein the business self service layer further comprises a workspace that provides for business context data.

15. An article of manufacture, comprising:
a machine readable medium having instructions that when executed by a machine cause the machine to execute a method, comprising:
receiving a first business process;
storing an output parameter of the first business process;
receiving a second business process;
receiving an input parameter of the second business process based on the output parameter of the first business process;
processing the input parameter in the second business process based on the business logic;
storing the output parameter of the second business process; and
displaying the output parameter of the first business process and the input parameter of the second business process.

16. The article of manufacture in claim 15, further comprising modeling of the first business process.

17. The article of manufacture in claim 15, further comprising modeling of the second business process.

18. The article of manufacture in claim 15, further comprising receiving an input parameter of the first business process.

19. The article of manufacture in claim 15, further comprising validating an input parameter of the first business process.

20. The article of manufacture in claim 15, further comprising processing the input parameter of the first business process.
